(19) United States
(12) Patent Application Publication
(10) Pub. No.: US 2008/0270880 A1
(43) Pub. Date: Oct. 30, 2008

(54) SYSTEM AND METHOD FOR MEMORALIZING PREDETERMINED EVENTS

(76) Inventor: Lynne Becker, James Island, SC (US)

Correspondence Address: MCNAIR LAW FIRM, P.A., P.O. BOX 10827, GREENVILLE, SC, 29603-0827, US

(21) Appl. No.: 12/105,457

(22) Filed: Apr. 18, 2008

Related U.S. Application Data
(60) Provisional application No. 60/925,337, filed on Apr. 19, 2007.
(60) Provisional application No. 60/933,451, filed on Jun. 6, 2007.

(51) Int. Cl. G06F 17/00

(52) U.S. Cl. 715/202

(57) ABSTRACT

A system for memorializing milestones in a child's development comprising a computer readable medium; a set of visual pages with pre-determining text included on at least one virtual page representing development milestones of a child's life, and a set of computer readable instructions for receiving virtual page selection information from a user, creating a virtual album from the selected virtual pages, receiving user information, associating the user information with the virtual album, receiving a digital image from a user, associating the digital image with a virtual page of the virtual album, and transmitting the virtual album to the user

### CLAIM OF PRIORITY

This application claims priority on U.S. Provisional Patent Application Ser. No. 60/925,337 filed Apr. 19, 2007 and entitled System and Method for Memorializing Predetermined Events and U.S. Provisional Patent Applicant Ser. No. 60/933,451 filed Jun. 6, 2007 entitled System and Method for Memorializing Predetermined Events.

### FIELD OF THE INVENTION

This invention is directed to a system and method for memorializing life events, and more specifically, to a system and method for integrating images with predetermined milestones representing life events.

### BACKGROUND OF THE INVENTION

Every parent desires to document the early stages of their child's development, particularly in the first year of life. The first year of a child's life is literally full of firsts. Obviously, it is very desirable to document these firsts as much as possible since they only occur once. Milestones representing these “firsts” involve when children speak their first words, drink their first drink from a regular cup, and first walk. The sentimental value of memorializing these events is invaluable, particularly when they are memorialized by photographs or other video or audio recordings. Traditionally, when parents decide to have a second child, the life of the parents has become more hectic and memorializing these milestones is considerably more challenging. This challenge is increased since the parents may not have readily available a camera or video recorder to memorialize these milestones.

Additionally, it is typical for the second child to have different milestones, sleeping habits, eating routines, health, size and “firsts” occur at different times.

When milestones are not recorded, there is a potential for regret and guilt by the parents. Many are familiar with the conversation which can occur with the second child that includes the phrase, “Why aren't there any pictures of me.” This problem is exasperated for the third and subsequent children.

It would be advantageous to have a system and method for memorializing milestones of a child's development which is both easy to use as well as convenient. This is particularly true since, when the actual milestone occurs, the parent may not have a camera or a video camera readily available.

Accordingly, it is an object of this invention to provide a system for allowing the easy and automated process of capturing images representing a child's development, particularly milestones, and having these assembled into a photo album.

### SUMMARY OF THE INVENTION

The invention herein is a system for memorializing milestones in a child's development comprising: a computer readable medium; a set of visual pages with pre-determining text included on at least one virtual page representing development milestones of a child's life; and, a set of computer readable instructions embodied in the computer readable medium for receiving a digital image from a user, storing the digital image on the computer readable medium, determining a current visual page from the set of visual pages representing the next milestone in a child's development, associating the digital image with the current visual page so that the current visual page will display showing the digital image located in a predetermined area on the visual page, indicating that the next visual page in the set of visual pages is the current visual page.

### DESCRIPTION OF THE DRAWINGS

The invention will be more readily understood from a reading of the following specification and by reference to the accompanying drawings.

FIG. 1 is an illustration of the prior art;

FIG. 2 is a schematic of the invention;

FIG. 3 is a schematic of the inventory;

FIG. 4 is a flowchart of the invention;

FIG. 5A is a flowchart of the invention;

FIG. 5B is a continuation of a flowchart of the invention;

FIG. 6 is a schematic of the invention; and,

FIG. 7 is a schematic of the invention.

### DESCRIPTION OF THE INVENTION

An object or module is a section of computer readable code embodied in a computer. The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result. These steps require physical manipulations of physical quantities such as electrical or magnetic signals capable of being stored, transferred, combined, compared, or otherwise manipulated readable medium that is designed to perform a specific task or tasks. Actual computer or executable code or computer readable code may not be contained within one file or one storage medium, but may span several computers or storage mediums. The term “host” and “server” may be hardware, software, or a combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code. These computer readable instructions may be loaded onto a general purpose computer, special purpose computer, or other programmable data processing apparatus to produce a machine such that the instructions will execute on a computer or other data processing apparatus to create a means for implementing the functions specified in the flowchart block or blocks.

These computer readable instructions may also be stored in a computer readable medium that can direct a computer or other programmable data processing apparatus to function in a particular manner, such that the instructions stored in a computer readable medium produce an article of manufacture including instruction means that implement the functions specified in the flowchart block or blocks. Computer program instructions may also be loaded onto a computer or other programmable apparatus to produce a computer executed process such that the instructions are executed on the computer or other programmable apparatus provide steps for implementing the functions specified in the flowchart block or blocks. Accordingly, elements of the flowchart support combinations of means for performing the special functions, combination of steps for performing the specified functions and program instruction means for performing the specified functions. It will be understood that each block of the flowchart illustrations can be implemented by special purpose hardware based computer systems that perform the specified functions, or steps, or combinations of special purpose hardware or computer instructions. The present invention is now described more fully herein with reference to the drawings in which the preferred embodiment of the invention is shown. This invention may, however, be embodied any many different forms and should not be construed as limited to the embodiment set forth herein. Rather, these embodiments are provided so that this disclosure will be thorough and complete and will fully convey the scope of the invention to those skilled in the art.

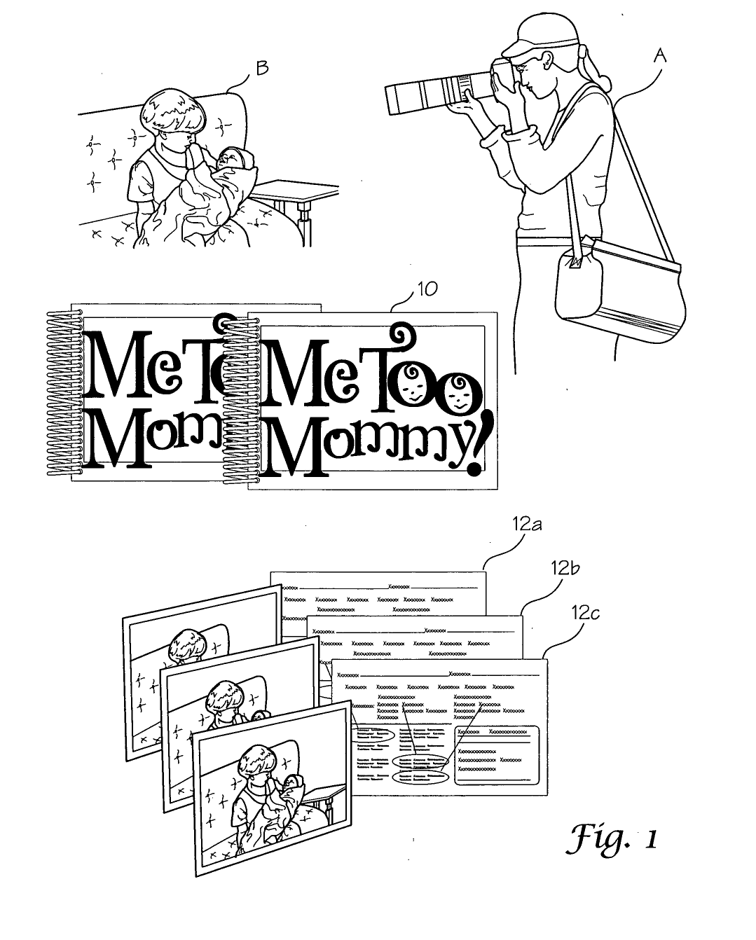

Referring now to FIG. 1, traditionally a parent, shown generally as A, will take a photograph, shown generally as B, of their child to capture a particular milestone. This photograph is typically placed into a photo album which contains pages 12a, 12b and 12c. The photo album can contain information such as date, descriptions and other information that is associated with the photograph inserted in the photo album so that the child's development is memorialized. However, this requires the parent to have a camera or other means of taking a photograph, to have the photograph converted to a physical form such as a print, to have a photo album, to insert the photo in pages in the album and to create text to accompany the milestone. During the development of children, it is sometimes difficult to have all these steps accomplished, particularly given the schedules of parents in modern society. Nevertheless, the need to memorialize the child's milestone is just important today as ever. Previous attempts for on-line photo albums require substantial amount of manipulation by the user to create the album, as well as the album pages that are contained within the photo album.

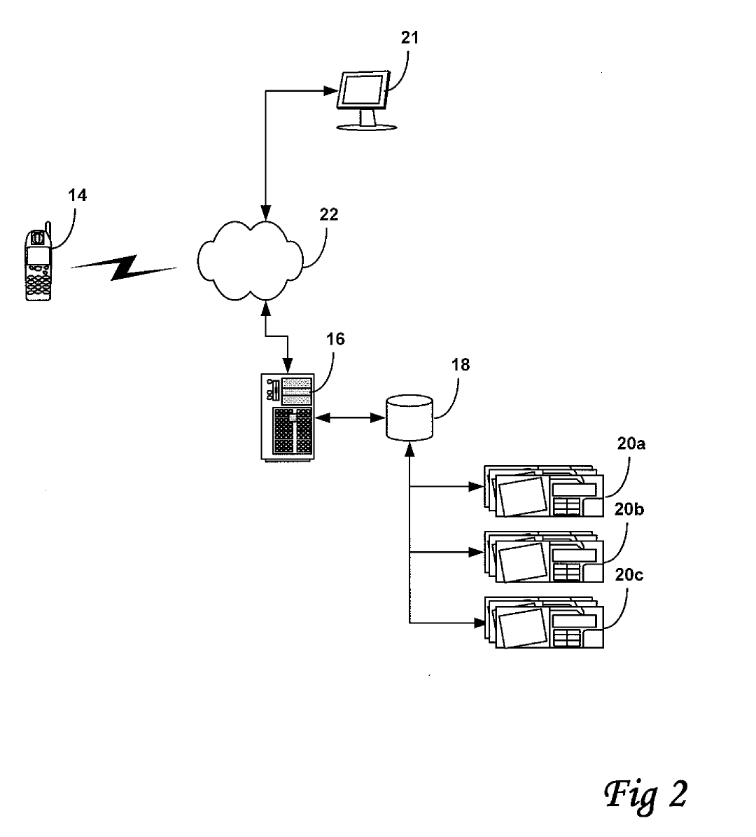

Referring now to FIG. 2, this invention is shown automating the process of recording milestones so that it is significantly easier to memorialize a child's development without having to have the physical print or photo album. This invention takes advantage of society's wide use of a cellular phone 14 that includes a digital camera. The cellular phone is simple and easy to use and has the ability to transmit pictures to remote locations such as server 16. Server 16 contains a set of computer readable instructions for storing the received digital photo and virtual photo album that allows camera 14 to upload pictures to server 16 to be held in a computer readable medium 18 that can be integrated into a virtual album. Attempts to assist parents have included on-line photo albums. However, Server 16 can include photo albums 20a, 20b and 20c, so that multiple users can use server 16 and have their individualized photo albums stored and for use. Further, a single user can have multiple photo albums for each child, family trips, reunions or other associations. The digital photograph is then taken with digital camera 14 or some other type imaging device, transmitted through network 22 to server 16 and stored in computer readable medium 18. Computer readable instructions can automatically place the photo on a particular page of a photo album such as by milestone. A milestone is an event in a child's development that is worth memorializing such as first steps, first word, and other such items.

The computer readable instructions can track the particular milestone that will be accomplished next. For example, milestone one maybe taken home from the hospital. If the computer readable instructions have milestone one as the selected milestone, when a digital image is received from cellular phone 14, it is automatically placed on the virtual album page associated with milestone one, indicating that the child was brought home from the hospital.

The computer readable instructions can then automatically advance to milestone two, for example which may include the infant's first bath. Therefore, the next image received from digital device 14 would have the digital image received automatically placed on virtual album page two, representing this second particular milestone. The computer readable instructions will then advance to the third milestone.

In one embodiment, the child's birthday is stored in the computer readable medium. When a picture is uploaded from the user, the date associated with the photograph is included with the digital image. The milestone associated with the digital image can then be calculated as the different between the child's birthday and the date information of the digital image. For example, if the child's was born Dec. 9, 1999 and the digital image as date information of Jun. 15, 2000, the computer readable instructions would calculate the difference between the child's birthday and the digital image date of six months and 6 days. Therefore, the computer readable instructions can determine that the digital image should be placed at in the virtual page representing the six month birthday of the child.

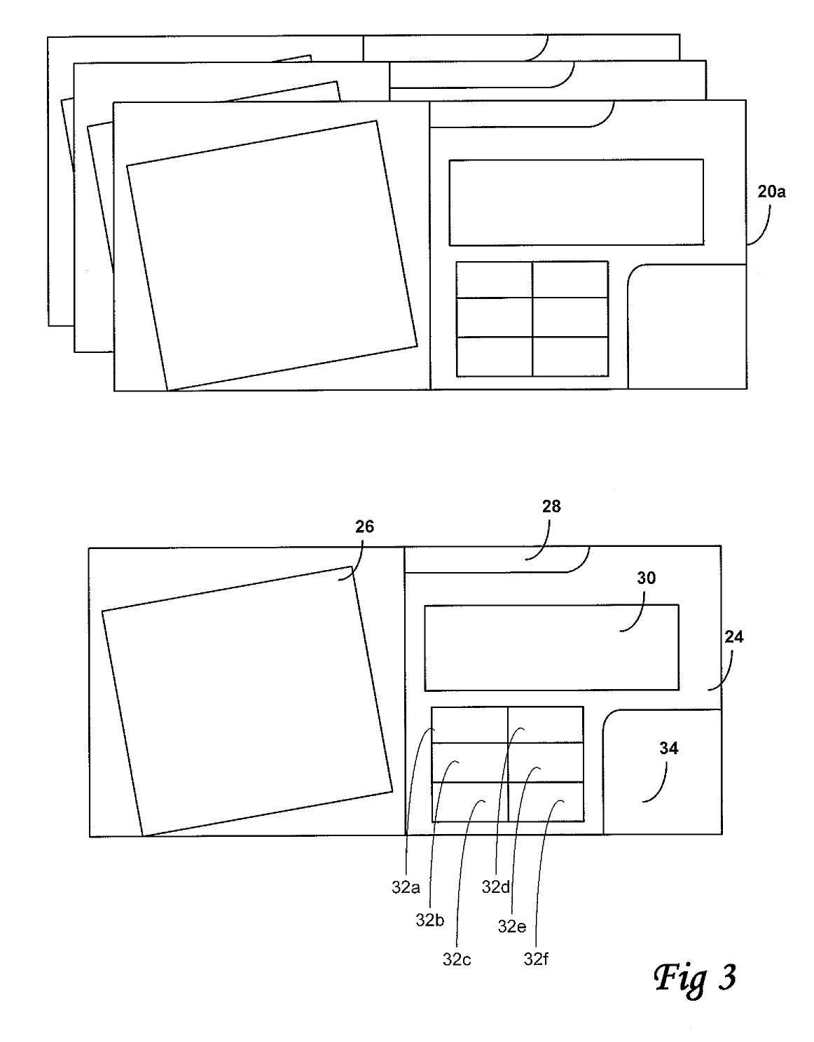

Referring now to FIG. 3, photo album 20a is shown having a plurality of photo album pages. A single photo album page 24 is also shown. The photo album page may include the location for the photograph at 26, date and time information at 28, textural information at 30, and pre-printed information organized in particular segments shown as 32a through 32f. Additional text can be included in location 34 which can contain such information as memorandum or other such items.

In one embodiment, text area 30 contains seven columns representing the days of the week so that each day of the month, which is listed in section 28, can be displayed. In this event, pre-printed text 32a can be selected associated with a day or date in area 30. For example, an arrow pointing to the actual block, representing the day in which that pre-printed milestone occurred can show where the selected pre-printed text is associated. Therefore, it is easy for the parent to identify particular milestones and use pre-printed text that identify the occurrences for that particular timeframe without having to free-hand or enter the text. This benefit is achieved through the computer readable instructions of the server.

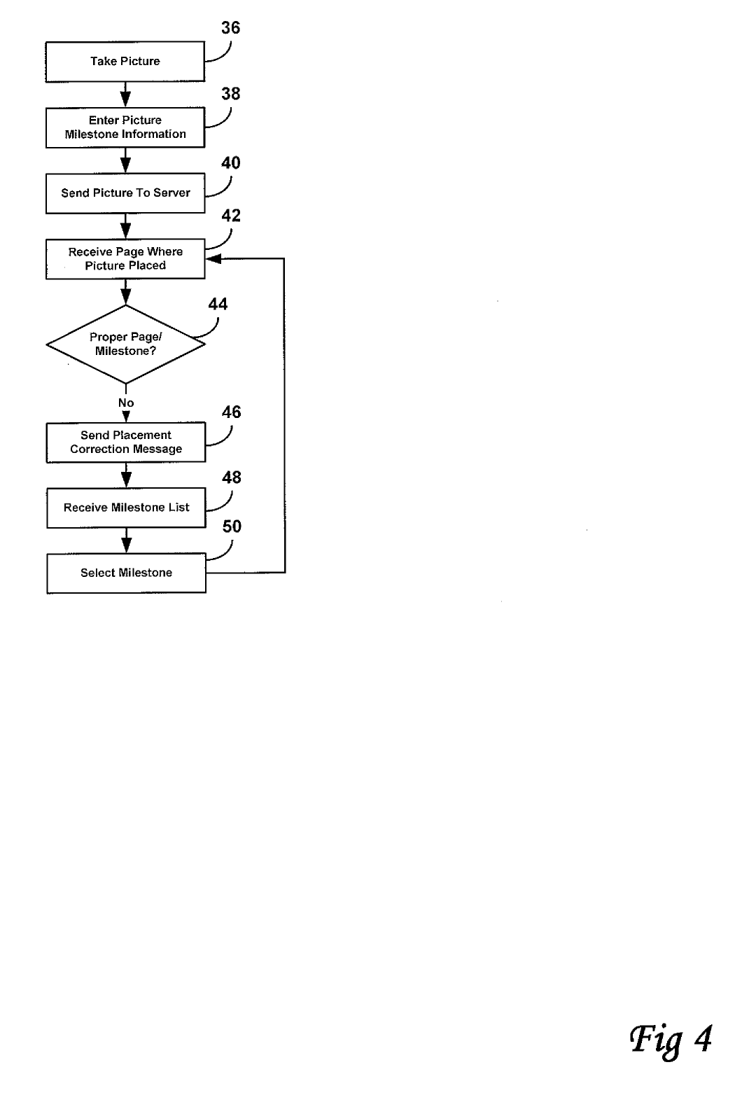

Referring now to FIG. 4, a picture is taken at block 36. In one embodiment, information concerning the milestone in which the picture is associated can be attached to the image from the cell phone 14 and transmitted at block 38. The picture is then sent to the server in block 40. In one embodiment, the page where the picture will be placed according to milestone can be transmitted to the cellular phone in step 42. The user of the cell phone can then determine whether the picture was placed at the proper location in step 44. If the answer is yes, no further action is needed. However, if the answer is no, the correction information can be transmitted back to the server in step 46, as well as being provided a milestone list at block 48. The user of the cell phone can select the milestone to associate with the digital image and video in block 50. The process can then return to block 42 showing the user where the picture was actually placed within the photo album.

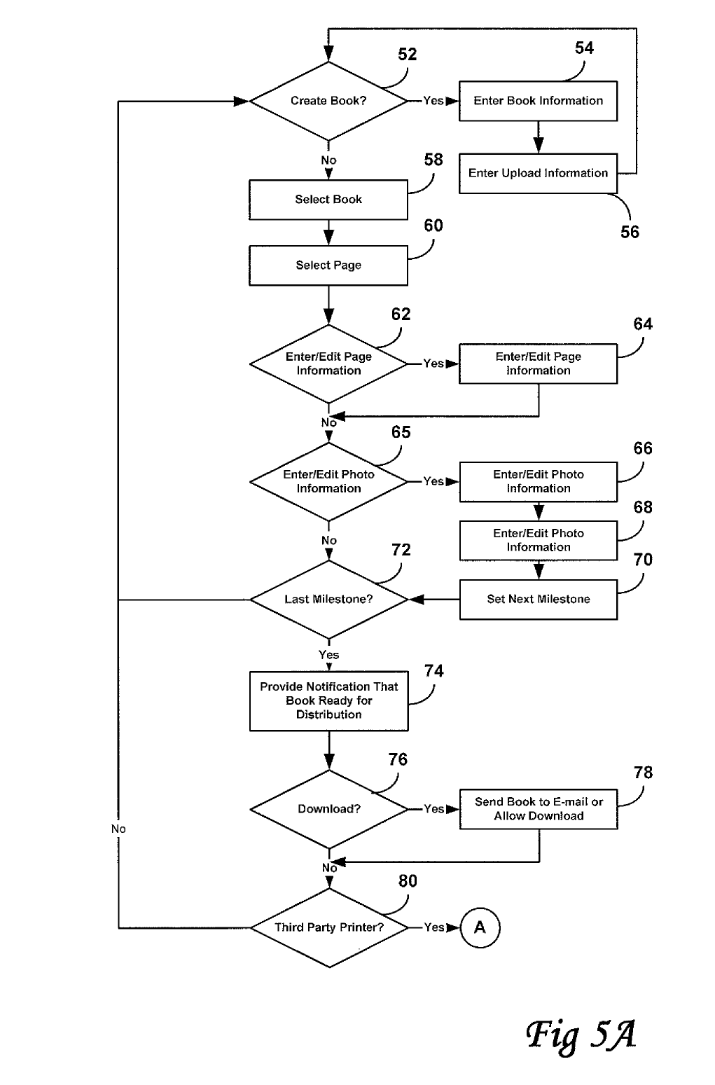

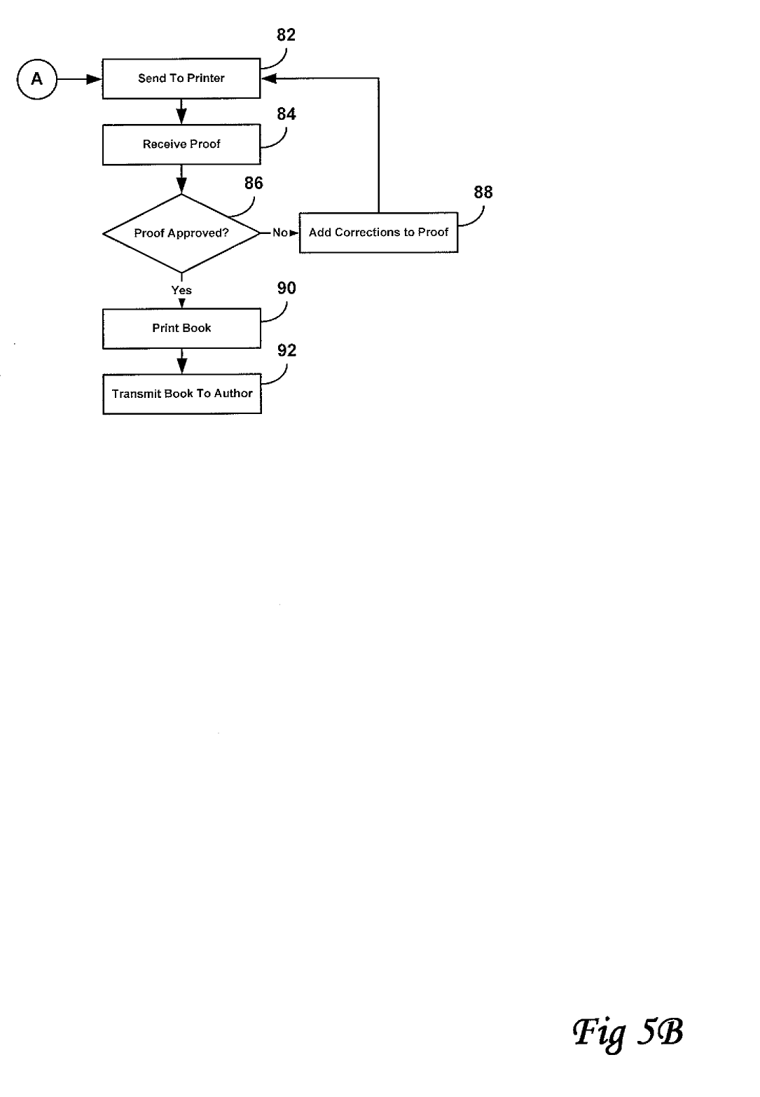

Referring now to FIG. 5A, the photo album can be created on the server through the use of a terminal 21 of FIG. 2. In block 52, a determination is made on whether an album or photo book needs to be created. If the answer is yes, the album information is entered at block 54. The album information can include milestones, as well as pages pre-selected which are associated with specific milestones already contained on the server. Upload information is then entered at block 56 so that the phone used by the user can be associated with a particular album or albums so the image transmitted from that user can be associated with a particular album. In block 52, if there is no need to create an album, the user can select an album to work with in block 58 and the user can select a page to work with in block 60. The determination is made on whether to enter or edit page information in block 62, and if the answer is yes, the page information is entered or edited in block 64. A determination can be made on whether to enter or edit any photo information at block 65 and the photo to be manipulated is selected at block 66. When selected, the photo information can be entered or edited at block 68. The next milestone is then set at block 70 and the determination is made at block 72 whether this is the last milestone. If it is the last milestone, then notification can be provided that the album is ready for distribution in block 74. A decision is made at block 76 whether to download the album. If the answer is yes, the album is downloaded or sent by email in block 78. Otherwise, a determination is made whether the album should be sent to third party printer at block 80. If the answer is yes, the album is sent to the printer at block 82. A proof is received from the printer. In one embodiment in block 84, a determination is made whether the proof is approved in block 86. If the answer is no, corrections to the proof are made at block 88 and the information is transmitted back to the printer. If the proof is accepted, the album is printed at block 90 and transmitted to the author in block 92.

Information that can be uploaded to the server from the cellular phone can include a date with the photograph so that the image can be automatically dated when inserted into the album. The date can also be taken from the server, system date and time and put into the virtual page of the album if appropriate. In one embodiment, the information sent from the cellular phone can also include which album to insert the picture into, in the event that the parent has multiple albums on the server.

It should be understood that there are multiple variations of the virtual album which can be used with this invention. For example, and not by way of limitation, virtual albums can include baby books which can include virtual pages such as those found in a traditional baby book. A daddy's first book can include virtual pages such as first golf lesson, first fish caught, first touchdown, etc. A toddler's book can include virtual pages associated with toddler milestones such as eats with fingers, plays with a ball, turns pages in a book, etc.

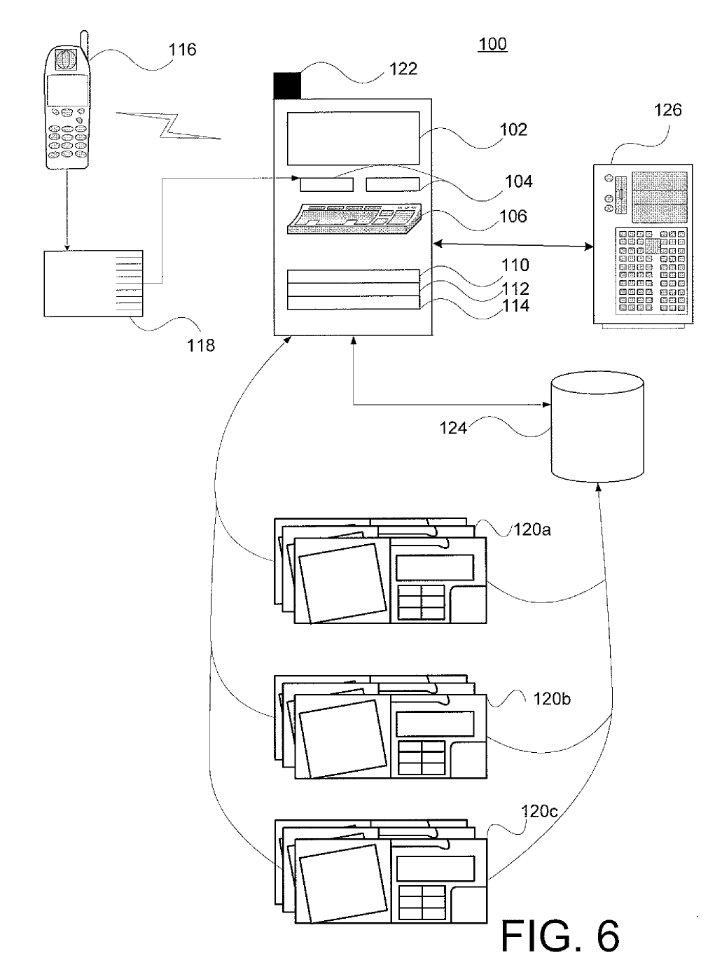

In addition to the foregoing, multiple embodiments are possible for printing or producing both virtual albums and hardcopy albums. Referring now to FIG. 6, a kiosk is illustrated for use in printing hardcopies. This embodiment may be used to print any manner of hard copy, including everything from postcards and birth announcements, to full bound copies of photo albums or the like. Kiosk 100 can have an inventory of paper and a printer so that album pages can be printed from the kiosk. The inventory of paper can be blank or can be pre-printed. In one embodiment, the inventory of paper can be pre-printed as described in FIG. 3.

Using handheld device 116, which can be any electronic device such as a personal data assistant (PDA), but preferably includes a digital camera such as found in many cellular phones, a user has the option of either wirelessly connecting to kiosk 100 or using a memory card, thumb drive, or other storage device 118 to connect directly.

A user may wirelessly connect to kiosk 100 through wireless receiver 122. Wireless receivers employing technology such as Bluetooth® are easily adapted to this purpose. In this manner, photos stored on handheld device 116 can be wirelessly retrieved to kiosk 100 and can be stored in computer readable medium 124. A user may alternatively connect to kiosk 100 by removing memory card 118 from handheld device 116 and inserting memory card 118 into a matching card slot 104 disposed on kiosk 100. The images stored on memory card 118 can then be transferred to computer readable medium 124.

Internal processor 126 contains a set of computer readable instructions for retrieving the digital images and allowing the user to position the images on album pages contained in the kiosk. Therefore, the kiosk allows the user to upload images and integrate them into an album for printing. In another embodiment, the photos are already integrated in the photo album and the user can download the photos and album to the kiosk for printing.

A user employs these computer readable instructions when using kiosk 100 by first selecting an appropriate command from those displayed on screen 102, using keyboard 106. In another embodiment, the appropriate command could be displayed in one of a set of available buttons that the user presses on screen 102, where screen 102 is touch sensitive. Once the user has directed kiosk 100 to upload photos, the computer readable instructions can then upload the photos into computer readable medium 124 for storage.

The user may then select any of a number of recorded milestones to associate with one or more stored photos. Computer readable instructions on computer readable medium 124 can automatically place a photo on a particular page of a photo album such as by milestone. Computer readable instructions can also present a particular group of milestones that may be accomplished in order. These recorded milestones may then be assembled into a photo album.

In the same manner as described with reference to FIG. 2, the computer readable instructions on computer readable medium 124 can present a particular group of milestones that may be accomplished in order. For example, milestone one may be taking baby home from the hospital. The computer readable instructions can then automatically advance to milestone two, and so forth.

In one embodiment, the child's birthday is stored in the computer readable medium 124. When a picture is uploaded from the user, the date associated with the photograph is included with the digital image. The milestone associated with the digital image can then be calculated as the difference between the child's birthday and the date information of the digital image so that the computer readable instructions can determine the likely placement of the digital image at the appropriate milestone page.

Computer readable medium 124 can include photo albums 120a, 120b and 120c, so that multiple users can use processor 126 and computer readable medium 124 to create individualized virtual albums using kiosk 100. These virtual albums could then be saved on memory card 118 for transfer to the user's handheld device 116 or home computer (not shown).

In another embodiment, paper trays 110, 112, and 114 can contain hard copies of photo albums 120a, 120b, and 120c as blank templates to be printed with photos uploaded from cellular phone 14. If the user prefers hardcopies, that option is selected using keyboard 106 or touch screen 102 and computer readable code directs a printing mechanism (not shown) within kiosk 100 to print the photo album by pulling one or more of photo album 120a, 120b, and 120c from trays 110, 112, and 114. If the user prefers only single pages, computer readable code directs the same printing mechanism to print only selected pages.

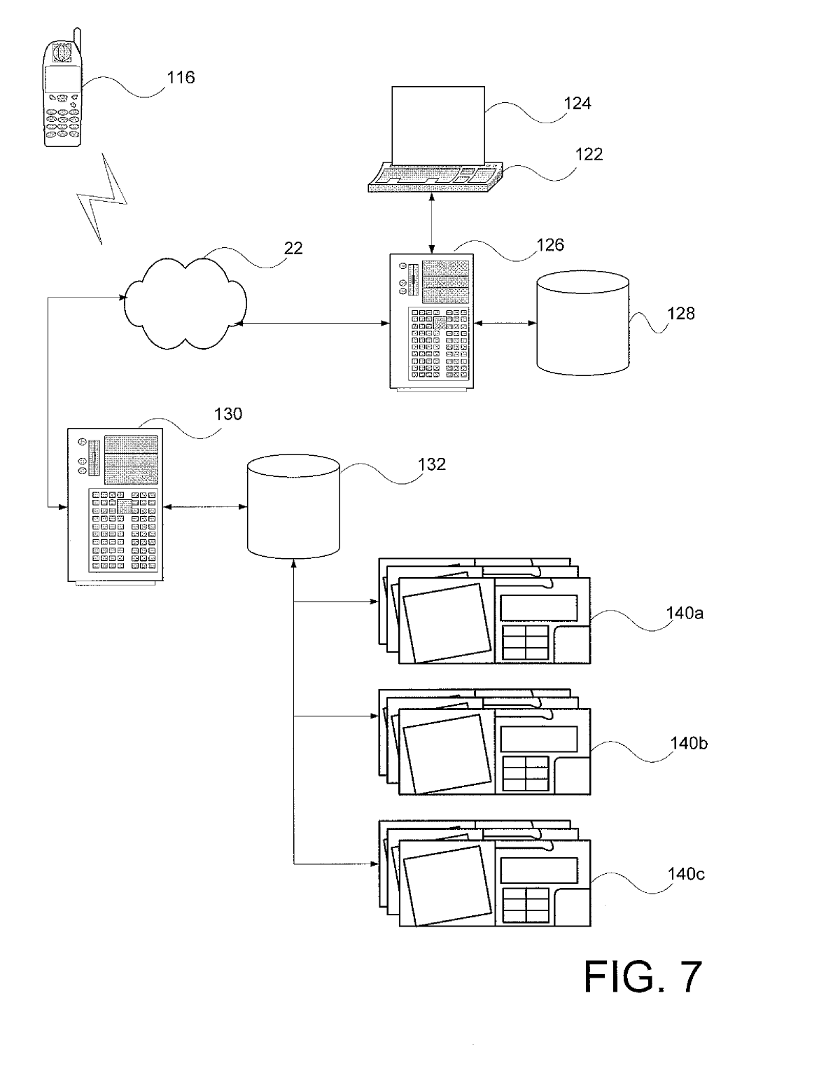

The invention also allows a user to create and order virtual photo albums and hardcopy photo albums using a personal computer connected to a web-based server over the Internet. Referring now to FIG. 7, a system is illustrated for web-based use of one embodiment of the invention.

Using handheld device 116, a user first transfers stored photos to a computer readable medium 128 connected to his personal computer 126 by sending the photos over a network 22, preferably using the Internet. Any number of transfer methods are possible. In one embodiment, email is generally used in most cases such that the photos are attached to an email that is sent by handheld device 116 to an email account accessible for download by the user on personal computer 126.

Personal computer 126 contains a set of computer readable instructions for storing the received digital photos on computer readable medium 128. The photos are then viewed using computer screen 124 and keyboard 122 so that the user can select those photos he wishes to add to a virtual photo album.

When the user wishes to compile photos into a virtual album, the user uses personal computer 126 to access web-based server 130, preferably using the Internet to logon to a designated Internet web address associated with server 130. Computer readable instructions are stored on computer readable medium 132 to facilitate the user's logon access and to direct the process of creating a virtual photo album.

Once logged on, the computer readable instructions stored on computer readable medium 132 direct and allow the user to upload the photos stored on computer readable medium 128. In another embodiment, computer readable instructions are stored on handheld device 116 that allow a user to access server 130 directly through network 22, thereby avoiding the extra step of uploading pictures using personal computer 126.

Once photos are uploaded, computer readable instructions allow the user to associate each photo with a particular milestone or event. Similar to the embodiment illustrated in FIG. 2, server 130 and computer readable medium 132 include photo albums 140a, 140b and 140c, so that multiple users can use server 130 and have their individualized photo albums stored and for use. In addition, a single user can have multiple photo albums for each child, family trips, reunions or other associations. The user may then select any of a number of recorded milestones to associate with one or more stored photos. Computer readable instructions on computer readable medium 132 can automatically place a photo on a particular page of a photo album. Computer readable instructions can also present a particular group of milestones that may be accomplished in order. These recorded milestones may then be assembled into a photo album.

Once all photos are associated with particular criterion, the completed virtual photo album may be reviewed using screen 124 as the computer readable instructions direct transmission of the virtual album over network 22. If satisfied with the assembled virtual album, the user may choose to obtain a final copy by download The final copy could, of course, comprise a slide show, print at home, hard copy, electronic copy, or the like, and could even be scheduled for later pick up or delivery to the user's home. If the owner of the computer readable instructions stored on 132 wishes to provide this download for a fee, he may employ additional instructions to direct the monetary transfer necessary to complete the sale.

While the best mode of the invention have been described using specific terms, such descriptions are for illustrative purposes only, and it is to be understood that changes and variations may be made without departing from the spirit or scope of the following claims.

What is claimed is:

1. A system for memorializing milestones in a child's development comprising:
a computer readable medium;
a set of visual pages with pre-determining text included on at least one virtual page representing development milestones of a child's life; and,
a set of computer readable instructions embodied in said computer readable medium for receiving a digital image from a user, storing said digital image on said computer readable medium, determining a current visual page from said set of visual pages representing the next milestone in a child's development, associating said digital image with said current visual page so that said current visual page will display showing said digital image located in a predetermined area on said visual page, indicating that the next visual page in the set of visual pages is the current visual page.

2. The system of claim 1 wherein said computer readable instructions include instructions for determining date information from said digital image file information and associating said current visual page with said date information can be displayed on said visual page.

3. The system of claim 2 wherein said computer readable instructions include instructions for receiving birthday information of a child, storing said birthday information in said computer readable medium, determining which visual page should be associated with said digital image according to a calculation of said date information from said digital image and said birthday information, associating said digital image with said determined visual page so that said digital image is associated with the corresponding visual page.

4. The system of claim 1 wherein said computer readable instructions include instructions for associating a plurality of visual pages into a photo album.

5. The system of claim 1 wherein said computer readable instructions include instructions for receiving text and associating said text with said current visual page so that said visual page will be displayed with said text.

6. The system of claim 1 wherein said computer readable instructions include instructions for disassociating said digital image from said current visual page and associating said digital image with another visual page.

7. The system of claim 1 including:
a set of photo album information representing a plurality of photo albums having visual pages; and, said computer readable instructions include instructions for receiving photo album selection information, associating said digital image with a visual page of one of said photo albums according to said photo album selection information.

8. The system of claim 1 wherein said set of computer readable instructions include instructions for transmitting said visual page to a printer so that said visual page can be printed.

9. The system of claim 1 and 4 including:
a remote computer readable medium in communications with said computer readable medium;
a printer in communications with said remote computer readable medium; and,
a set of remote computer readable instructions embodied in said remote compute readable medium for receiving said digital image, visual page and said photo album and printing said visual pages, digital images and photo album on said printer.

10. The system of claim 1 including:
a portable computer readable medium for communicating with said computer readable medium; and,
said set of computer readable instructions include instructions for storing said digital image and said visual page on said portable computer readable medium.

11. The system of claim 10 including:
a remote computer readable medium for communicating with said portable compute readable medium;
a printer in communications with said remote computer readable medium; and,
a set of remote computer readable instructions embodied in said remote compute readable medium for retrieving said digital image and visual page from said portable computer readable medium and printing said digital image and visual page on said printer.

12. The system of claim 4 including:
a portable computer readable medium for communicating with said computer readable medium; and,
said set of computer readable instructions include instructions for storing said digital image and said visual page on said portable computer readable medium.

13. The system of claim 12 including:
a remote computer readable medium for communicating with said portable compute readable medium;
a printer in communications with said remote computer readable medium; and,
a set of remote computer readable instructions embodied in said remote compute readable medium for retrieving said digital image and visual page from said portable computer readable medium and printing said digital image and visual page on said printer.

14. The system of claim 1 wherein said computer readable instructions include instructions for transmitting said digital image and said visual page to a printer so that the printer can print said digital image and said visual page for delivery or pick up by the user.

15. The system of claim 1 including:
a digital image section on said visual page;
a date and time information section on said digital page;
a textual information section on said visual page;
pre-printed information in said visual page; and,
an additional text section on said visual page.
